(19) United States
(12) Patent Application Publication
(10) Pub. No.: US 2017/0337246 A1
(43) Pub. Date: Nov. 23, 2017

(54) BIG-DATA PROCESSING ACCELERATOR AND BIG-DATA PROCESSING SYSTEM THEREOF

(71) Applicant: WASAI technology inc., Taipei City (TW)

(72) Inventors: Chih-Chun Chang, New Taipei City (TW); Tsung-Kai Hung, Taipei City (TW)

(21) Appl. No.: 15/600,702

(22) Filed: May 20, 2017

Related U.S. Application Data
(60) Provisional application No. 62/339,804, filed on May 20, 2016.

(51) Int. Cl. G06F 17/30; G06F 9/50

(52) U.S. Cl. CPC G06F 17/30516; G06F 17/30598; G06F 17/30563; G06F 17/30575; G06F 9/5083; G06F 17/30522; G06F 17/30115; G06F 17/30587

(57) ABSTRACT

A big-data processing accelerator operated under Apache Hive-on-Tez framework, the Hive-on-Spark framework, or the SparkSQL framework includes an operator controller and an operator programming module. The operator controller executes a plurality of Map operators and at least one Reduce operator according to an execution sequence. The operator programming module defines the execution sequence to execute the plurality of Map operators and the at least one Reduce operator based on the operator controller's hardware configuration and a directed acyclic graph.

### CROSS-REFERENCE TO RELATED APPLICATION(S)

The application claims priority to U.S. Provisional Application No. 62339804, filed on May 20, 2016, entitled “Hive-on-Tez Accelerator w/ORC Proposed Software/Hardware Structure”, which is incorporated by reference herein in its entirety.

### TECHNICAL FIELD

The present invention relates to a hardware processing accelerator and a processing system utilizing such a hardware processing accelerator, and more particularly, to a big-data processing accelerator and a big-data processing system that utilizes such a big-data processing accelerator.

### BACKGROUND

A common coding language for big-data processing commands and procedures is the SQL language. Among the available SQL-based tools for processing big-data commands and procedures, the Apache Hive framework is a popular data warehouse that provides data summarization, query, and analysis.

The Apache Hive framework primarily applies Map and Reduce operators to process data. Map operators are primarily used for data filtering and data sorting. Reduce operators are primarily used for data summarization. Under the Apache Hive framework, however, a Map operator must be followed by a Reduce operator, which significantly limits the framework's data processing efficiency.

### SUMMARY

This document discloses a big-data processing accelerator operated under the Apache Hive-on-Tez framework, the Hive-on-Spark framework, or the SparkSQL framework. The big-data processing accelerator comprises an operator controller and an operator programming module. The operator controller is configured to execute a plurality of Map operators and at least one Reduce operator according to an execution sequence. The execution sequence in which the plurality of Map operators and the at least one Reduce operator are executed is defined by the operator programming module based on the operator controller's hardware configuration and a directed acyclic graph (DAG).

This document also discloses a big-data processing system operated under the Apache Hive-on-Tez framework, the Hive-on-Spark framework, or the SparkSQL framework. The big-data processing system comprises a storage module, a data bus, a data read module, a data write module, and a big-data processing accelerator. The data bus is configured to receive raw data. The data read module is configured to transmit the raw data from the data bus to the storage module. The big-data processing accelerator comprises an operator controller and an operator programming module. The operator controller is configured to execute a plurality of Map operators and at least one Reduce operator pursuant to an execution sequence, using the raw data or an instant input data in the storage module as inputs. The execution sequence is defined by an operator programming module based on the operator controller's hardware configuration and a directed acyclic graph (DAG). The operator controller is also configured to generate a processed data or an instant output data. The operator controller is further configured to store the processed data or the instant output data in the storage module. The data write module is configured to transmit the processed data from the storage module to the data bus. The data bus is configured to output the processed data.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the present invention is not limited to the precise arrangements and instrumentalities shown.

In the drawings:

FIG. 1 illustrates a schematic view of a big-data processing framework based on softwares.

FIG. 2 illustrates a schematic view of a big-data processing framework based on softwares and hardwares according to one example of the present invention.

FIG. 3 illustrates a big-data processing system according to one example of the present invention.

FIG. 4 illustrates a data flow diagram of the big-data processing system shown in FIG. 3.

FIG. 5 illustrates an operator/data view of how the operator controller 360 works according to one example of the present invention.

FIG. 6 schematically illustrates a sample execution sequence in which the operator programming module executes the Map/Reduce operators.

FIGS. 7-9 illustrate how the operator programming module shown in FIG. 3 defines clocks in which Map/Reduce operators are executed.

FIGS. 10 and 11 illustrate exemplary diagrams for parallelism and/or pipelining shown in FIGS. 8-9.

### DETAILED DESCRIPTION

Reference will now be made in detail to the examples of the invention, which are illustrated in the accompanying drawings. Wherever possible, the same reference numbers will be used throughout the drawings to refer to the same or like parts.

To overcome Apache Hive's shortcomings, this document discloses a novel big-data processing accelerator based on a Hive-on-Tez (i.e., Apache Tez™) framework, the Hive-on-Spark framework, or the SparkSQL framework. This document also discloses a big-data processing system utilizing such a novel processing accelerator. The Apache Tez™ framework, the Hive-on-Spark framework, or the SparkSQL framework generalizes Map and Reduce tasks by exposing interfaces for generic data processing tasks, which consist of a triplet of interfaces: input, output and processor. More particularly, Apache Tez™ extends the possible ways of which individual tasks can be linked together. For example, any arbitrary DAG can be executed in Apache Tez™, the Hive-on-Spark framework, or the SparkSQL framework.

The disclosed big-data processing accelerator uses and leverages hardware to improve efficiency. Specifically, the disclosed big-data processing accelerator is dynamically coded/programmed based on its own hardware configuration and the definitions of software operators in the Hive-on-Tez framework, the Hive-on-Spark framework, or the SparkSQL framework.

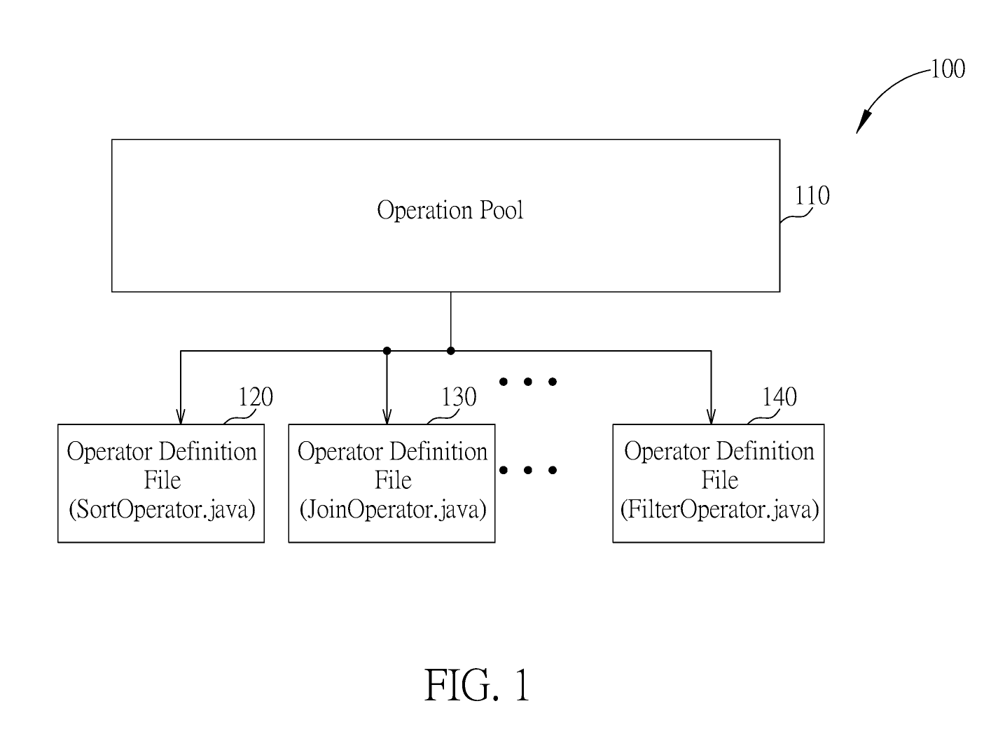

FIG. 1 illustrates a schematic view of a big-data processing framework 100 based on pure softwares. The big-data processing framework 100 may be based on the Apache Hive framework, the Hive-on-Tez framework, the Hive-on-Spark framework, or the SparkSQL framework. The big-data processing framework 100 pre-programs a plurality of Map operators and/or Reduce operators stored in an operator pool 110 into a plurality of operator definition files, for examples, operator definition files 120, 130, and 140 that may respectively defined as “SortOperator.java”, “JoinOperator.java”, “FilterOperator.java”, i.e., softwares. The operator pool 110 may be designed based on the Apache Hive framework. Each operator definition file 120, 130, or 140 dedicates to a specific function, such as a sort function, a join function, or a filter function.

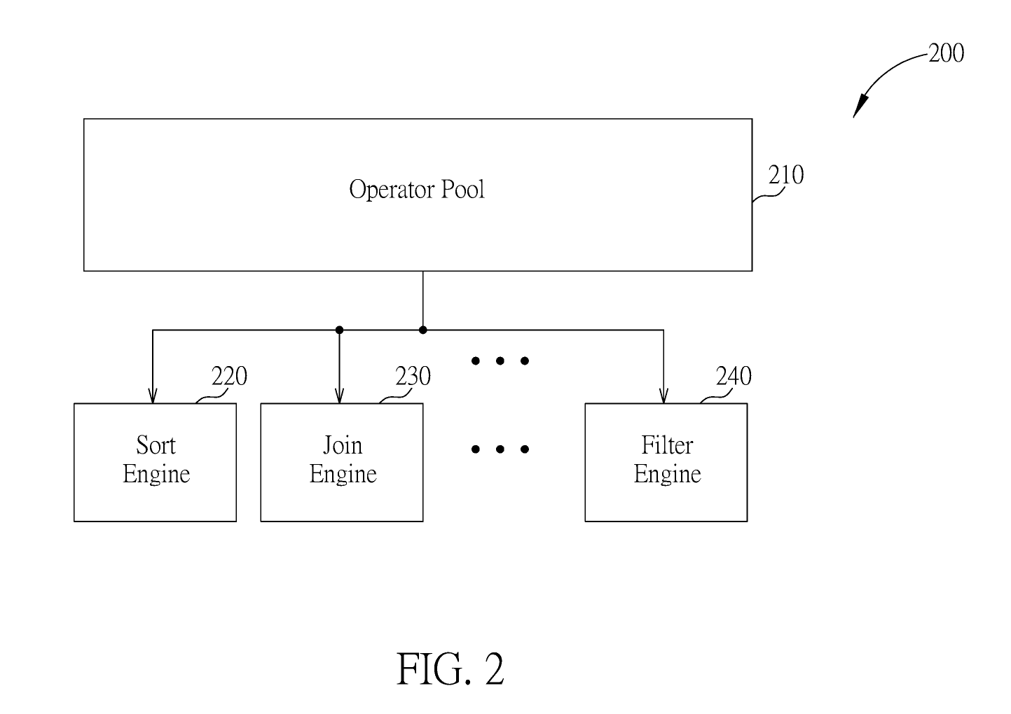

FIG. 2 illustrates a schematic view of a big-data processing framework 200 based on softwares and hardwares according to one example of the present invention. The big-data processing framework 200 may be based on the Hive-on-Tez framework, the Hive-on-Spark framework, or the SparkSQL framework. The big-data processing framework 200 includes at least an operator instruction pool 210 that is based on the Hive-on-Tez framework, the Hive-on-Spark framework, or the SparkSQL framework, and further includes a plurality of functional engines, i.e., hardwares, such as a sort engine 220, a join engine 230, and a filter engine 240. Note that the Apache Hive framework cannot be used on the big-data processing framework 200 primarily because of its lack of flexibility in its operator execution sequence that will be introduced later.

The sort engine 220 is a dynamically-programmed hardware that functions similarly to the operator definition file 120, but is coded/programmed differently from the operator definition file 120. Similarly, the join engine 230 is a dynamically-programmed hardware that has the same search function as the operator definition file 130, but is coded/programmed differently from the operator definition file 130. The filter engine 240 is also a dynamically-programmed hardware that has the same match function as the operator definition files 140, but with different codings.

In one example, each of the sort engine 220, the join engine 230, and the filter engine 240 may be dynamically programmed to acquire different functions depending on the data processing requirements. That is, the search engine 220 may be re-programmed to become a filter engine 240 depending on the big-data processing framework 200's requirements.

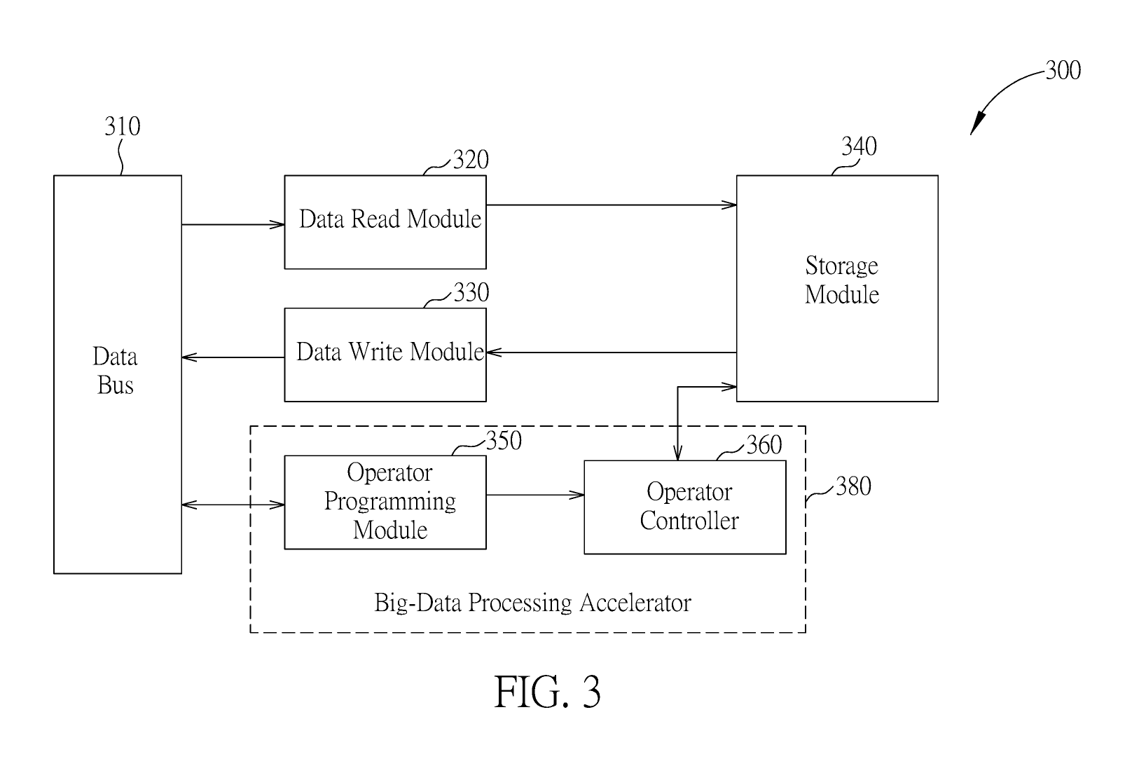

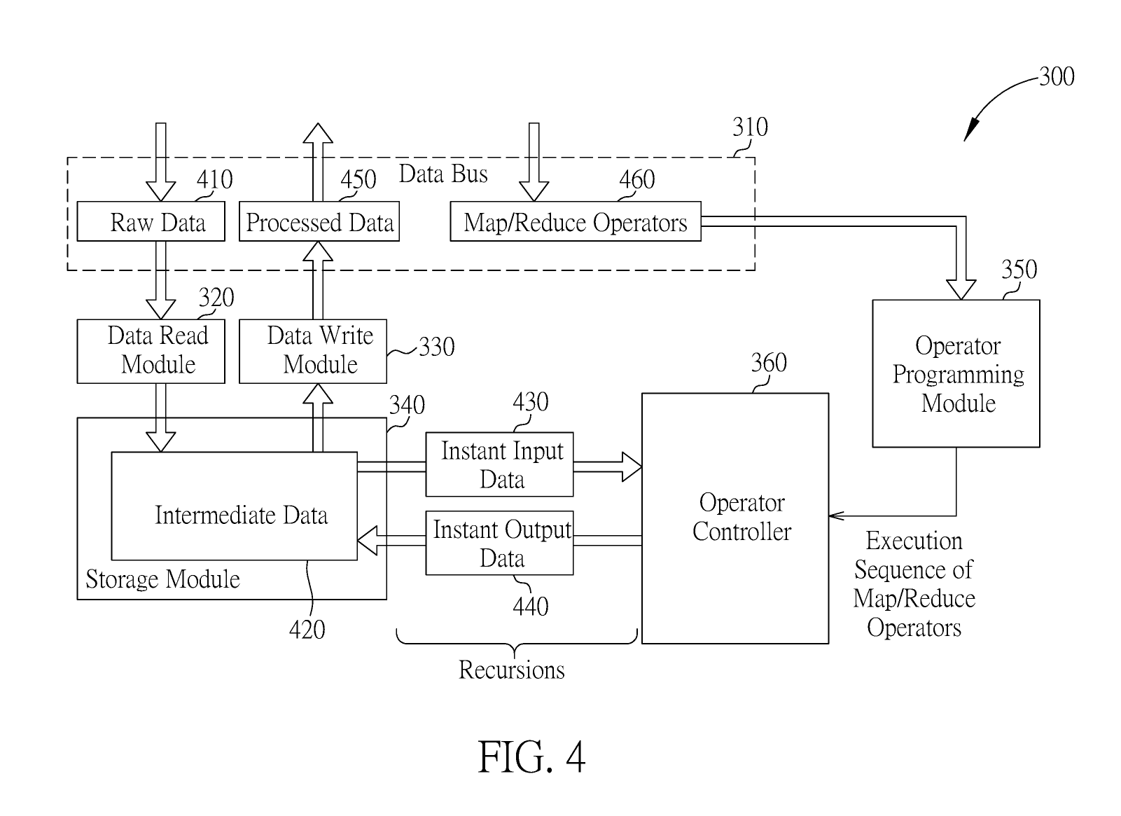

FIG. 3 illustrates a big-data processing system 300 according to one example of the present invention. The big-data processing system 300 includes a data bus 310, a data read module 320, a data write module 330, a storage module 340, and a big-data processing accelerator 380. The big-data processing accelerator 380 includes (1) an operator programming module 350 that may correspond to the operator pool 210, and (2) at least one operator controller 360 that may correspond to one of the functional engines in FIG. 2, e.g., the sort engine 220, the search engine 230 or the match engine 240. FIG. 4 is a data flow diagram of the big-data processing system 300.

In one example, the storage module 340 includes a plurality of dual-port random access memory (DPRAM) units.

When the big-data processing system 300 processes data, the data bus 310 receives raw data 410 from an external CPU, and the data read module 320 transmits the raw data 410 to the storage module 340 to generate an intermediate data 420. In one example, the data read module 320 is a direct memory access (DMA) read module that improves the efficiency of reading data from the external CPU. The data bus 310 also transmits Map operators and/or Reduce operators (i.e., Map/Reduce operators 460) from the external CPU to the operator programming module 350. The operator programming module 350 dynamically defines an execution sequence in which the operator controller 360 executes the Map/Reduce operators 460 based on the operator controller 360's hardware configuration. The operator programming module 350 also transmits the Map/Reduce operators 460 and the defined execution sequence to the operator controller 360.

The operator controller 360 processes the raw data 410, a.k.a., the initial phase of the intermediate data 420, to generate a processed data 450, i.e., the final phase of the intermediate data 420. The data write module 330 transmits the processed data 450 from the storage module 340 to the data bus 310 and then to the external CPU. The processed data 450 is the result of processing numerous big-data calculations on the raw data 410. The manner in which the operator controller 360 processes the raw data 410 to generate the processed data 450 involves multiple phases. An instant input data 430 is a specific instant of the intermediate data 420 that is inputted to and processed by the operator controller 360. The instant input data 430 may include data to be used by Map operators (“Map data”) and data to be used by Reduce operators (“Reduce data”). An instant output data 440 is an instant of the intermediate data 420 that is processed and outputted by operator controller 360. The instant output data 440 may include data generated by Map operators and data generated by Reduce operators.

The operator controller 360 extracts an instant input data 430 from the intermediate data 420, processes the instant input data 430 by executing the Map operators and/or the Reduce operators according to the execution sequence dynamically defined by the operator programming module 350, generates instant output data 440, and transmits the instant output data 440 to the storage module 340 to update the intermediate data 420. After all the data processing phases are completed, the intermediate data 420 becomes the processed data 450. The processed data 450 is then transmitted to the data bus 310 via the data write module 330. In one example, the data write module 330 is a DMA write module that may improve the efficiency of writing data to the external CPU.

The operations of the big-data processing accelerator 380, including the operator programming module 350 and the big-data processing accelerator 360, will be discussed in detail next.

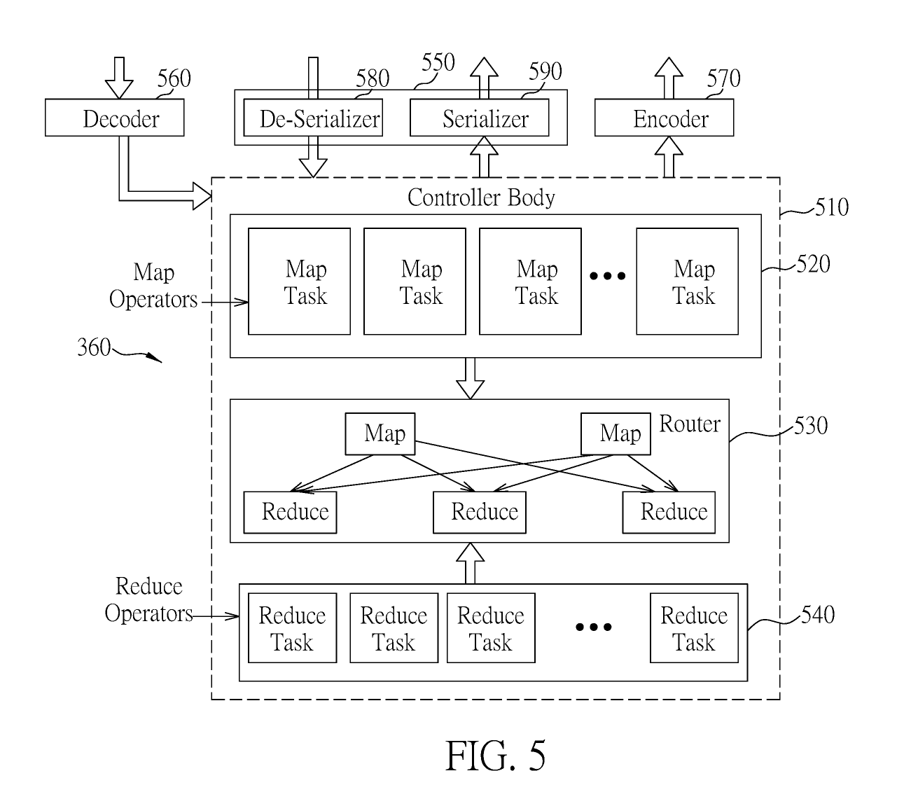

FIG. 5 illustrates an operator/data view of how the operator controller 360 operates according to one example of the present invention. The operator controller 360 may include a controller body 510, a decoder 560, an encoder 570, and a SerDe Module 550 that includes a de-serializer 580 and a serializer 590.

The controller body 510 includes a Map operator task 520, a router module 530, and a Reduce operator task 540. The Map operator task 520 receives Map operators from the operator programming module 350. Using the received Map operators, the operator controller 360 processes the instant input data 430 to generate a plurality of Map tasks. Similarly, the Reduce operator task 540 receives Reduce operators from the operator programming module 350. Using such Reduce operators, the operator controller 360 also processes the instant input data 430 to generate a plurality of Reduce tasks. The router module 530 processes the plurality of Map tasks and Reduce tasks based on an execution sequence defined by the operator programming module 350. The operator controller 360 subsequently generates an instant output data 440 and transmits such instant output data 440 to the storage module 340.

In one example, the storage module 340 applies a specific data format to buffer the intermediate data 420. However, the operator controller 360 may not be able to process such data format. Therefore, when the operator controller 360 receives the instant input data 430, the decoder 560 decodes the instant input data 430 to a data format understood by the operator controller 360 so it can process the instant input data 430. Similarly, when the instant output data 440 is to be stored in the storage module 340, the encoder 570 encodes the instant output data 440 to a specific data format so it can be stored by the storage module 340. In some examples, the specific data format includes the JSON format, the ORC format, or a columnar format. In some examples, the columnar format may the Avro format or the Parquet format; however, other columnar formats can still be applied for the specific data format.

In another example, the big-data processing accelerator 380 applies a plurality of operator controllers 360 to process data in parallel, a.k.a. parallelism. Pipelining may also be applied to increase processing throughput. Inter-process communication between the plurality of operator controllers 360 may be required for parallelism if computational tasks have a varied nature. Information transmitted via inter-process communications may also be serialized. The SerDe module 550 acts as the interface for communicating with other operator controllers 360 within the same big-data processing accelerator 380. Whenever information is sent to the operator controller 360 from a first operator controller 360 of the big-data processing accelerator 380, the de-serializer 580 de-serializes the incoming information so that the operator controller 360 can process the incoming information. Similarly, each time when the operator controller 360 sends information to the first operator controller or a second operator controller of the big-data processing accelerator 380, the serializer 590 serializes the information. The first or second operator controller follows the same de-serializing process described above so it can subsequently process the information.

Under the Apache Hive framework, a Map operator must be followed by a Reduce operator, which limits the framework's data processing efficiency. However, the Hive-on-Tez framework, the Hive-on-Spark framework, or the SparkSQL framework utilized by the big-data processing system 300 allows: (1) a Map operator followed by another Map operator; and (2) a Reduce operator followed by another Reduce operator. Such flexibility under the Hive-on-Tez framework, the Hive-on-Spark framework, or the SparkSQL framework improves the efficiency of the big-data processing system 300.

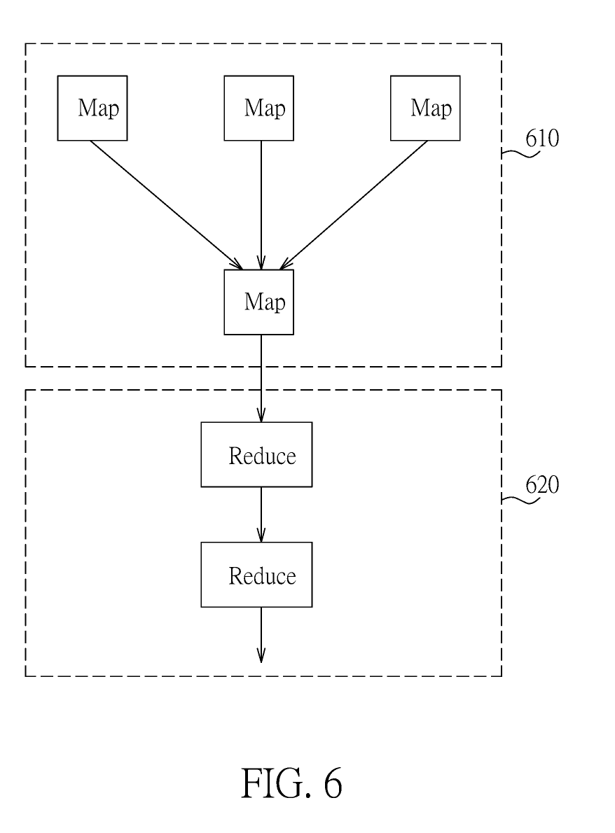

A direct acyclic graph (DAG)-based execution sequence used to execute the Map/Reduce operators may further improve data processing efficiency. In one example, the DAG-based execution sequence may include a plurality of Map operators and at least one Reduce operator. The Hive-on-Tez framework, the Hive-on-Spark framework, or the SparkSQL framework each provide the flexibility needed to implement such DAG configuration. In another example, the operator programming module 350 applies the Hive-on-Tez framework, the Hive-on-Spark framework, or the SparkSQL framework to define the execution sequence in which the Map/Reduce operators 460 are executed. FIG. 6, a DAG-based execution sequence, schematically illustrates an example of defining the execution sequence in which the operator controller 360 executes the Map/Reduce operators. Particularly, the operator programming module 350 aggregates all the Map operators into one DAG-based Map group 610, and aggregates all the Reduce operators into one DAG-based Reduce group 620.

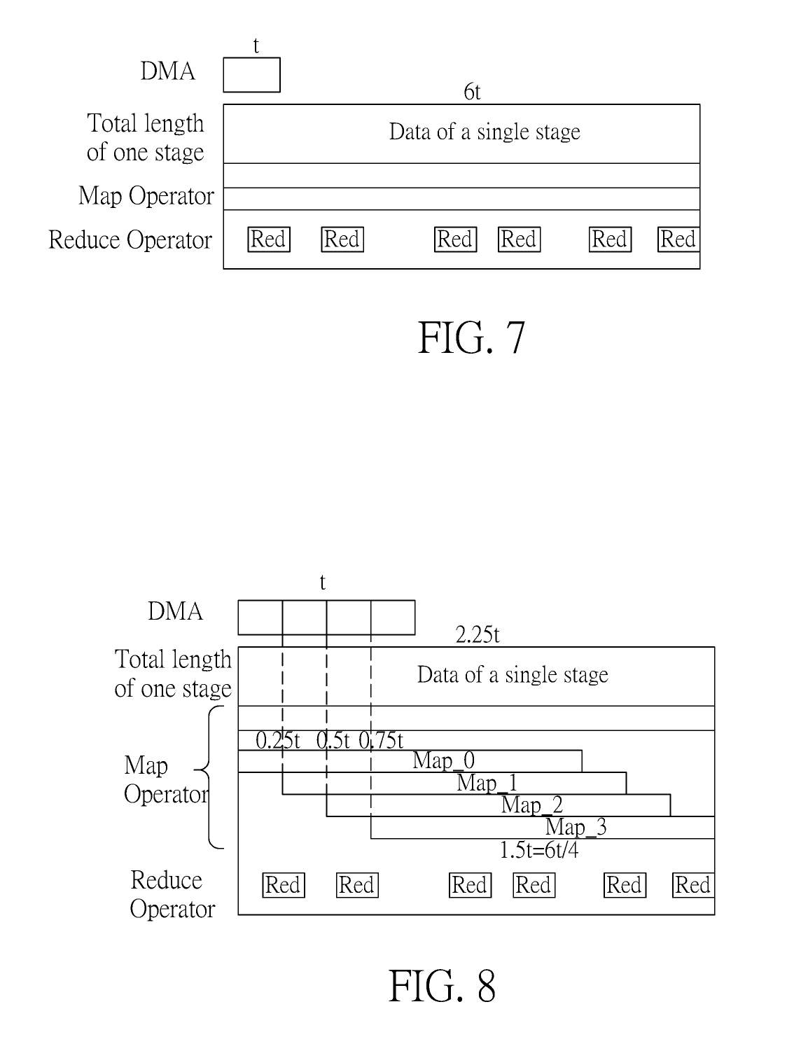

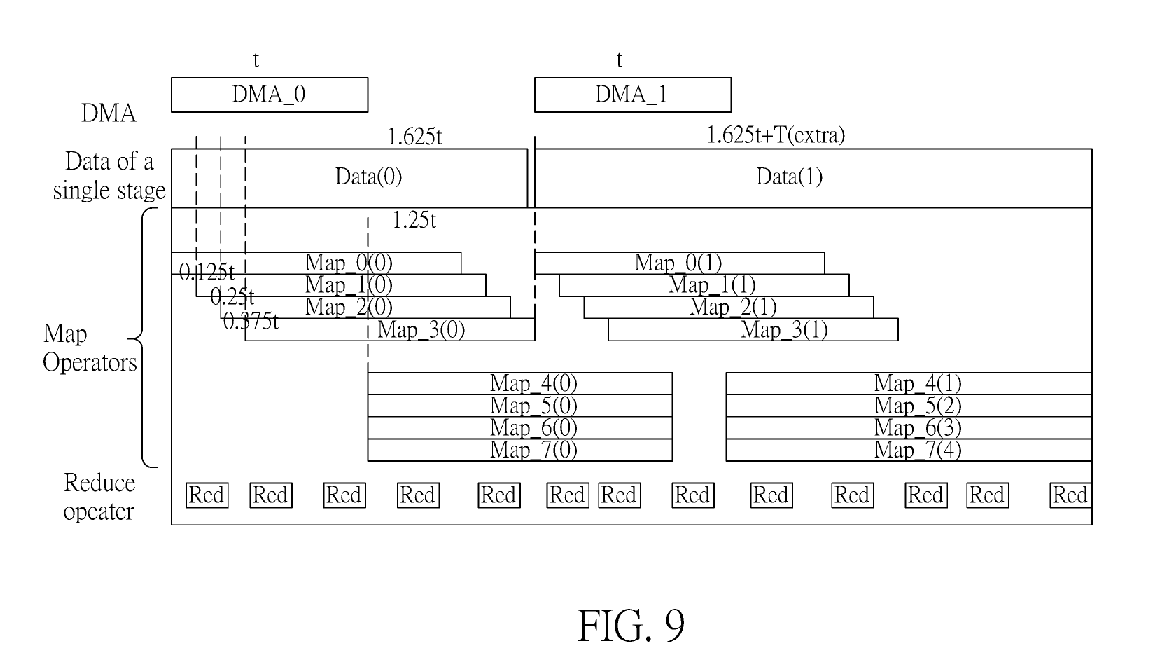

FIGS. 7-9 illustrate the operator programming module 350 defining clocks in which the Map/Reduce operators 460 are executed. In FIG. 7, no parallelism or pipelining is applied when there is only one operator controller 360. In FIG. 8, parallelism and/or pipelining is applied when four operator controllers 360 are used for Map operators and one operator controller 360 is used for Reduce operators. Similarly, FIG. 9 illustrates parallelism and/or pipelining when eight operator controllers 360 are used for Map operators and one operator controller 360 is used for Reduce operators. Note that the operator programming module 350 can implement parallelism and/or pipelining on the operator controllers 360 because the operator controllers 360 are hardwares. If the operator controllers 360 are implemented by pure software, e.g., by the operator definition files 120, 130, and 140, no clock coordination between the softwares can be applied; and execution of relevant softwares may suffer process stalls or task starvation.

In FIGS. 7-9, the data read module 320 is a DMA read module, and the data write module 330 is a DMA write module. The operator programming module 350 dynamically determines both an estimated processing time for each Map/Reduce operator and an estimated total processing time for all the Map/Reduce operators. The operator programming module 350 further dynamically determines a longest processing time because the operator requiring the longest processing time will be the bottleneck during parallelism and pipelining. The operator programming module 350 may use the longest processing time as a unit of partitioning Map and/or Reduce operators' parallel tasks or pipelining tasks, as shown in FIGS. 7-9. The reason is that using the longest processing time guarantees that each partitioned Map and/or Reduce operators' parallel task or pipelining task will be completed within the partition unit. In one example, the operator requiring the longest processing time is a Map operator.

A read time for the data read module 320 (or DMA) is set to be t. People who are skilled in the art knows that DMA may only read one Map operator at a time.

In FIG. 7, the operator programming module 350 determines that the longest processing time is 6t for a Map operator, and it is also the total processing time of all the operators in one stage.

In FIG. 8, because four operator controllers 360 are applied, the longest processing time of the Map operator is divided into

$$\frac{6 t}{4} = 1.5 t$$

for each Map operators: Map_0, Map_1, Map_2, and Map_3. The total processing time is reduced to 2.25t. Note that the operator Map_1 is executed 0.25t after the operator Map_0 is executed because the operator Map_1 cannot start reading data via DMA until the operator MAP_0 completes its task.

In FIG. 9, eight operator controllers 360 are applied (i.e., Map_0, Map_1, Map_2, Map_3, Map_4, Map_5, Map_6, Map_7). Because DMA operation is completed after the execution of Map_3, the execution results for Map_0, Map_1, Map_2, Map_3 can be used by Map_4, Map_5, Map_6, Map_7 as inputs, thereby no waiting time is required for Map_4, Map_5, Map_6, Map_7. Accordingly, the total processing time for one single stage is reduced to 1.625t.

As can be observed from FIGS. 7-9, parallelism and/or pipelining significantly improves the performance and efficiency of the operator controller 360 under the Hive-on-Tez framework, the Hive-on-Spark framework, or the SparkSQL framework.

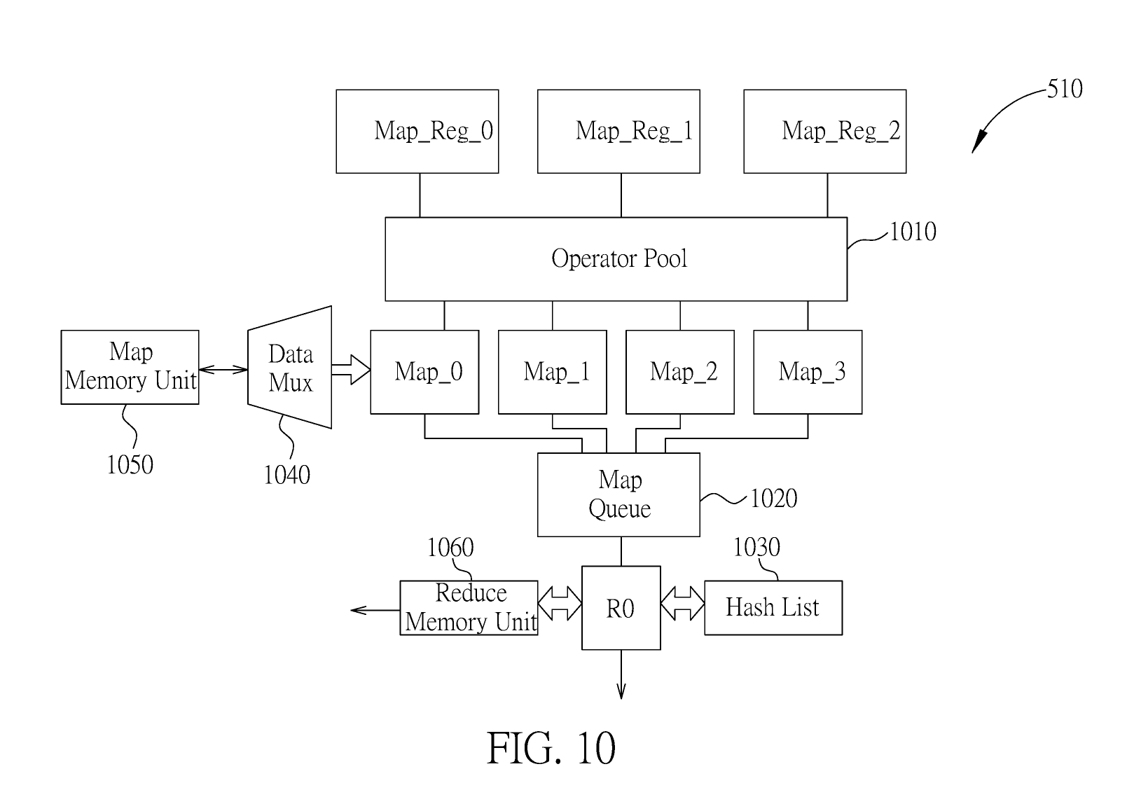

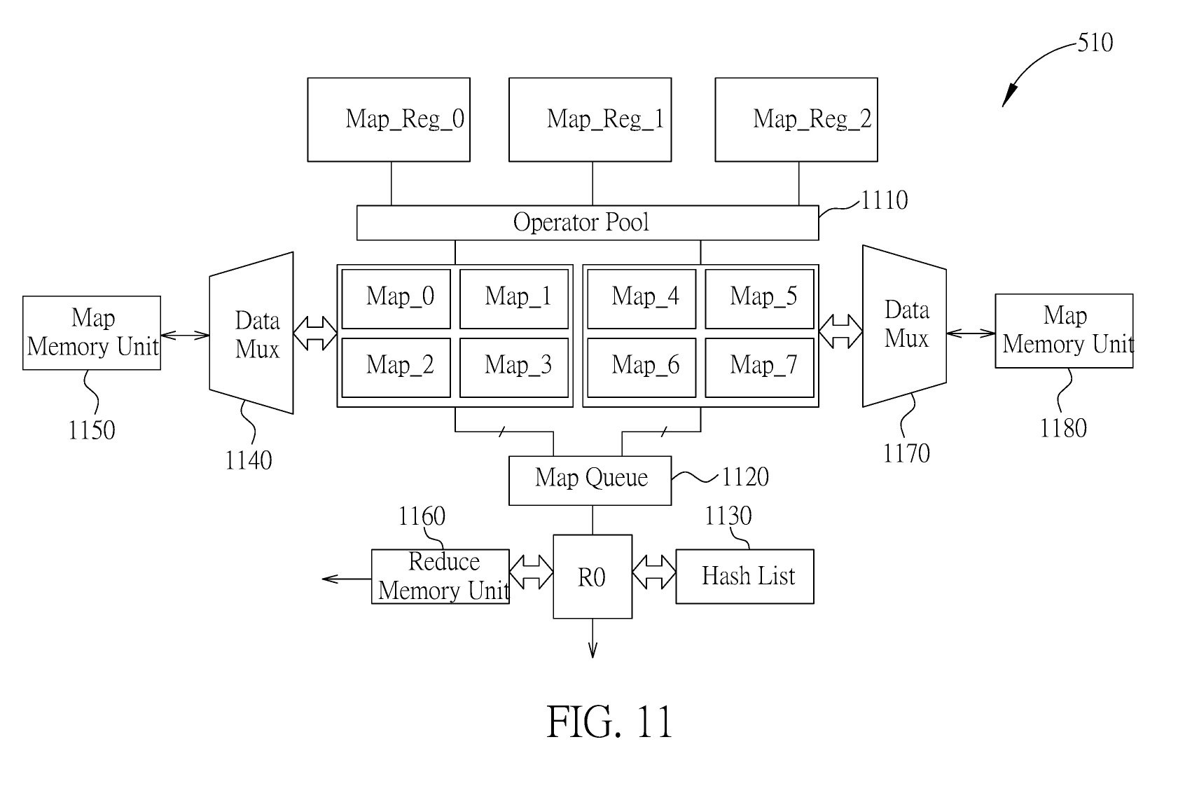

FIG. 10 illustrates parallelism and/or pipelining shown in FIG. 8 when the operator programming module 350 dynamically programs the controller body 510. In one example, the controller body 510 may have the following dynamically-programmed logic elements, including Map registers: Map_Reg_0, Map_Reg_1, and Map_Reg_2, an operator pool 1010, the Map tasks: Map_0, Map_1, Map_2, and Map_3, a data multiplexer 1040, a Map memory unit 1050, a Map queue 1020, a Reduce task R0, a hash list 1030, and a Reduce memory unit 1060.

The Map data portion of an instant input data 430, through a decoder 560, is buffered in the Map memory unit 1050. An execution sequence may direct specific Map register(s) to load the relevant Map operators from the operator pool 1010. The execution sequence may further direct, e.g., in the form of a MIPS command or a reduced instruction set computer (RISC) command that is used by the data multiplexer 1040 and complies with the operator controller 350's hardware configuration, the loading of the Map data from specific memory addresses of the Map memory unit 1050. Particularly, pursuant to the execution sequence, Map_0, Map_1, Map_2, and Map_3 may respectively load the relevant Map operators from specific Map registers (e.g., Map_0 may load Map operators from at least Map_Reg_0, Map_Reg_1, and/or Map_Reg_2). Each Map task may also load specific Map data buffered in the Map memory unit 1050 from memory addresses selected by the data multiplexer 1040 pursuant to the execution sequence. Map_0, Map_1, Map_2, and Map_3 may respectively perform their tasks using the loaded Map operators and Map data, and generate Map results accordingly. And the Map results are subsequently put into the Map queue 1020.

The Reduce task R0 processes specific Map results in the Map queue 1020 with the aid of the hash list 1030, and generates Reduce results accordingly. The Reduce results are then stored in the Reduce memory unit 1060. The instant output data 440 receives the Reduce results from the Reduce memory unit 1060 and is stored in the storage module 340.

FIG. 11 illustrates parallelism and/or pipelining shown in FIG. 9 when the operator programming module 350 dynamically programs the controller body 510. In one example, the controller body 510 may have the following dynamically-programmed logic elements, including Map Registers Map_Reg_0, Map_Reg_1, and Map_Reg_2, an operator pool 1110, the Map Tasks Map_0, Map_1, Map_2, and Map_3, Map_4, Map_5, Map_6, and Map_7, data multiplexers 1140 and 1170, Map memory units 1150 and 1180, a Map queue 1160, the Reduce task R0, a hash list 1130, and a Reduce memory unit 1160.

The Map data portion of an instant input data 430, through a decoder 560, is buffered in the Map memory units 1150 and 1180. An execution sequence may direct specific Map register(s) to load relevant Map operators from the operator pool 1110. The execution sequence may further direct, e.g., in the form of a MIPS command or a reduced instruction set computer (RISC) command that is used by the data multiplexers 1140 and 1170 and complies with the operator controller 350's hardware configuration, the loading of the Map data from specific memory addresses of the Map memory units 1150 and 1180. Particularly, pursuant to the execution sequence, Map_0, Map_1, Map_2, Map_3, Map_4, Map_5, Map_6, and Map_7 may respectively load the relevant Map operators from specific Map registers (e.g., Map_0 may load Map operators from at least one of Map_Reg_0, Map_Reg_1, and/or Map_Reg_2). Each Map task may also load specific Map data buffered in the Map memory units 1150 and 1180 from memory addresses selected by the data multiplexers 1140 and 1170 pursuant to the execution sequence. Map_0, Map_1, Map_2, Map_3, Map_4, Map_5, Map_6, and Map_7 may respectively perform their tasks using the loaded Map operators and Map data, and generate Map results accordingly. And the Map results are subsequently put into the Map queue 1120.

The Reduce task R0 processes specific Map results in the Map queue 1120 with the aid of the hash list 1130, and generates Reduce results accordingly. The Reduce results are then stored in the Reduce memory unit 1160. The instant output data 440 receives the Reduce results from the Reduce memory unit 1060 and is stored in the storage module 340.

One skill in the art understands that the search method associated with the application is similar to the search method in the context of the apps, which was described in detail previously. Therefore, all the embodiments, methods, systems and components relating to apps apply to applications.

1. A big-data processing accelerator operated under Apache Hive-on-Tez framework, the Hive-on-Spark framework, or the SparkSQL framework, comprising:
an operator controller, configured to execute a plurality of Map operators and at least one Reduce operator according to an execution sequence; and
an operator programming module, configured to define the execution sequence to execute the plurality of Map operators and the at least one Reduce operator based on the operator controller's hardware configuration and a directed acyclic graph (DAG).

2. The big-data processing accelerator of claim 1, wherein the operator programming module is further configured to dynamically analyze processing times of the plurality of Map operators and the at least one Reduce operator to determine a longest processing time.

3. The big-data processing accelerator of claim 2, wherein the operator programming module is further configured to partition tasks of the plurality of Map operators and the at least one Reduce operator based on the longest processing time, and the operator controller is further configured to concurrently execute the partitioned tasks.

4. The big-data processing accelerator of claim 3, wherein the operator programming module is further configured to dynamically define a pipeline order for the operator controller to execute the partitioned tasks based on the longest processing time.

5. The big-data processing accelerator of claim 1, further comprises:
a decoder, configured to decode raw data or intermediate data from a storage device to generate instant input data of a specific data format; and
an encoder, configured to encode instant output data and store the encoded instant output data of a specific data format to the storage device;
wherein the operator controller is further configured to execute the plurality of Map operators and the at least one Reduce operator to process the instant input data and to generate the instant output data respectively.

6. The big-data processing accelerator of claim 5, wherein the specific data format comprises the JSON format, the ORC format, the Avro format or the Parquet format.

7. The big-data processing accelerator of claim 5, wherein the specific data format comprises a columnar format.

8. The big-data processing accelerator of claim 1, further comprises:
a de-serialization module, configured to receive intermediate data from a first operator controller of the big-data processing accelerator and to de-serialize the intermediate data to generate instant data; and
a serialization module, configured to serialize instant output data and transmit the serialized instant output data to the first operator controller or a second operator controller of the big-data processing accelerator;
wherein the operator controller is further configured to execute the plurality of Map operators and the at least one Reduce operator to process the instant input data and to generate the instant output data respectively.

9. A big-data processing system operated under Apache Hive-on-Tez framework, the Hive-on-Spark framework, or the SparkSQL framework, comprising:
a storage module;
a data bus, configured to receive raw data;
a data read module, configured to transmit the raw data from the data bus to the storage module;
a big-data processing accelerator, comprising:
an operator controller, configured to execute a plurality of Map operators and at least one Reduce operator pursuant to an execution sequence, using the raw data or an instant input data in the storage module as inputs, configured to generate an instant output data or a processed data, and configured to store the instant output data or the processed data in the storage module; and
an operator programming module, configured to define the execution sequence based on the operator controller's hardware configuration and a directed acyclic graph (DAG); and
a data write module, configured to transmit the processed data from the storage module to the data bus;
wherein the data bus is further configured to output the processed data.

10. The big-data processing system of claim 9, wherein the data read module is a direct-memory access (DMA) read module.

11. The big-data processing system of claim 9, wherein the data write module is a direct-memory access (DMA) write module.

12. The big-data processing system of claim 9, wherein the storage module comprises a plurality of dual-port random access memory (DPRAM) units.

13. The big-data processing system of claim 9, wherein the operator programming module is further configured to dynamically analyze processing times of the plurality of Map operators and the at least one Reduce operator to determine a longest processing time.

14. The big-data processing system of claim 13, wherein the operator programming module is further configured to partition tasks of the plurality of Map operators and the at least one Reduce operator based on the longest processing time, and the operator controller is further configured to concurrently execute the partitioned tasks.

15. The big-data processing system of claim 14, wherein the operator programming module is further configured to dynamically define a pipeline order for the operator controller to execute the partitioned tasks based on the longest processing time.

16. The big-data processing system of claim 9, further comprises:
a decoder, configured to decode raw data or intermediate data from a storage device to generate instant input data of a specific data format; and
an encoder, configured to encode instant output data of the specific data format and store the encoded instant output data to the storage device;
wherein the operator controller is further configured to execute the plurality of Map operators and the at least one Reduce operator to process the instant input data and to generate the instant output data respectively.

17. The big-data processing system of claim 16, wherein the specific data format comprises the JSON format, the ORC format, the Avro format, or the Parquet format.

18. The big-data processing system of claim 16, wherein the specific data format comprises a columnar format.

19. The big-data processing system of claim 9, further comprises:
a de-serialization module, configured to receive intermediate data from a first operator controller of the big-data processing accelerator and de-serialize the intermediate data to generate instant output data; and
a serialization module, configured to serialize instant output data and relay the serialized instant output data to the first operator controller or a second operator controller of the big-data processing accelerator;
wherein the operator controller is further configured to execute the plurality of Map operators and the at least one Reduce operator to process the instant input data and to generate the instant output data respectively.
